(19) United States
(12) Patent Application Publication
(10) Pub. No.: US 2014/0292070 A1
(43) Pub. Date: Oct. 2, 2014

(54) ADAPTER TO PROVIDE POWER FROM A POWER SUPPLY

(71) Applicant: HEWLETT-PACKARD DEVELOPMENT COMPANY, L.P., Houston, TX (US)

(72) Inventors: Tzye Perng POH, Singapore (SG); Boo Siang CHOO, Singapore (SG); Leng Hoo TAN, Singapore (SG)

(73) Assignee: Hewlett-Packard Development Company, L.P., Houston, TX (US)

(21) Appl. No.: 13/851,345

(22) Filed: Mar. 27, 2013

(51) Int. Cl. H02J 1/00

(52) U.S. Cl. CPC H02J 1/00
USPC 307/4; 307/23

(57) ABSTRACT

According to an example, an adapter is to provide power to a plurality of electronic components from a first power supply. The adapter may include a first connector to connect to the first power supply, a plurality of second connectors to connect to the plurality of electronic components, a plurality of lines connecting the first connector to each of the second connectors, in which each of the plurality of electronic components is to receive power from the first power supply through the plurality of lines, and a controller to detect a fault in the receipt of power from a second power supply in an electronic component of the plurality of electronic components and in which the controller is to request allocation of power from the first power supply to supply power to the electronic component.

### BACKGROUND

Power supply devices are typically employed to supply many electronic components such as personal computers, industrial computers, servers, communication products or network products with stable electricity. Redundant power supply devices are often used to substantially ensure that the electronic components remain active even in the event of a power supply device failure. That is, if the power supply device that is currently supplying power to an electronic component fails, another one of the power supply devices supplies power to that electronic component to enable continuous operation of the electronic component.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of an adapter, according to an example of the present disclosure;

FIG. 2 depicts a simplified block diagram of a redundant power supply system containing the adapter depicted in FIG. 1, according to an example of the present disclosure; and

FIG. 3 depicts a flow diagram of a method of implementing an adapter to supply redundant power to a plurality of electronic components, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are an adapter and a method of implementing an adapter to supply redundant power to a plurality of electronic components from a power supply. As discussed herein, the adapter may include a first connector to connect to the power supply and a plurality of second connectors to connect to the electronic components. The adapter may also include a plurality of power lines connecting the first connector to the second connectors and a plurality of power converters to convert the voltage of power conducted through the plurality of power lines. The adapter may further include a controller to detect a fault in the receipt of power from a second power supply in an electronic component of the plurality of electronic components and to request allocation of power from the power supply to provide power to the electronic component.

In one regard, the adapter may operate transparently to both the power supply and the electronic components because the adapter may detect the fault and may automatically cause power from the power supply to be provided to the electronic components. As such, the power supply and the electronic components may operate normally when the adapter is implemented and may not need to determine that the adapter is being implemented.

The power converters in the adapter may convert the voltage of power supplied from the power supply to a voltage that is suitable for use by the electronic components. That is, for instance, the power supply may supply power at a voltage that is suitable for use by devices that are to receive power over Ethernet (PoE) and the electronic components may comprise non-PoE devices. In this example, the electronic components may require power at a lower voltage than is outputted by the power supply. Thus, the adapter disclosed herein may enable a power supply that is designed to provide redundant power to PoE devices may be implemented to provide redundant power to non-PoE devices.

In addition, the adapter disclosed herein may enable the power supply to provide redundant, standby power to a relatively larger number of electronic components than would be possible without the adapter. Particularly, the adapter disclosed herein may take a single power input and may split the power out to a plurality of electronic components. Accordingly, the adapter disclosed herein may substantially reduce or minimize the costs and space requirements associated with providing redundant power supplies to a relatively large number of electronic components, and particularly, non-PoE electronic components.

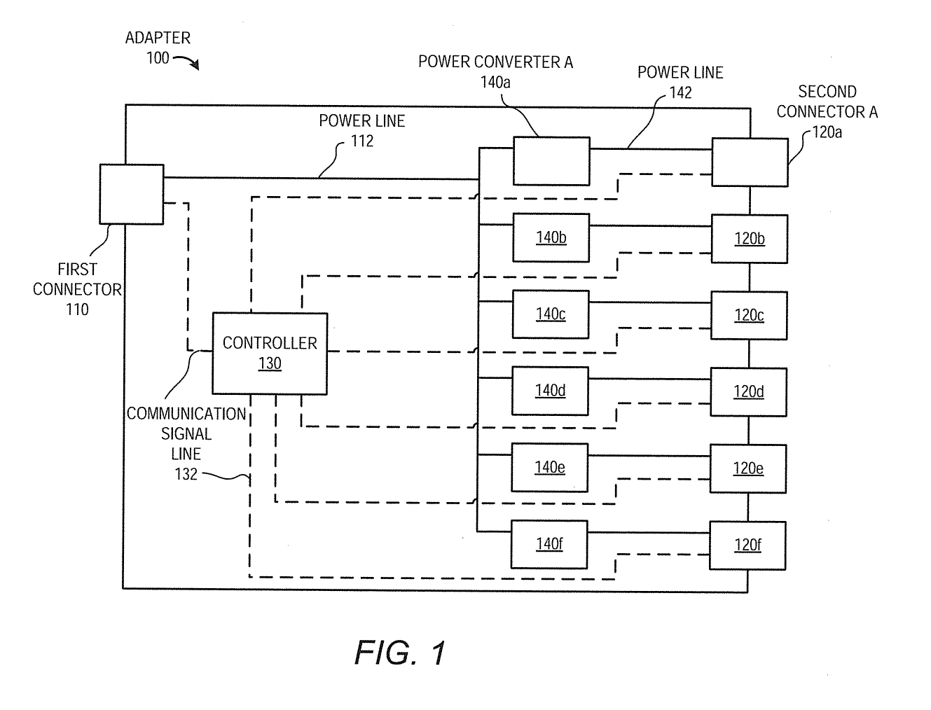

With reference first to FIG. 1, there is shown a simplified block diagram of an adapter 100, according to an example. It should be understood that the adapter 100 may include additional elements and that some of the elements depicted therein may be removed and/or modified without departing from a scope of the adapter 100. For instance, although the adapter 100 has been depicted as including a particular number of second connectors 120a-120f and power converters 140a-140f, it should be clearly understood that the adapter 100 may include any reasonable number of second connectors 120a-120f and power converters 140a-140f without departing from a scope of the adapter 100.

Generally speaking, the adapter 100 may be cable, a connector, or other physical structure over which power and data signals may be communicated. As shown in FIG. 1, the adapter 100 may include a first connector 110, a plurality of second connectors 120a-120f, a controller 130, and a plurality of power converters 140a-140f. The first connector 110 is in communication with each of the power converters 140a-140f through a power line 112, which may be split into multiple sub-lines. Alternatively, however, the first connector 110 may be in communication with each of the power converters 140a-140f through respective power lines 112, each connected to the first connector 110. In any regard, each of the power converters 140a-140f may be connected to respective ones of the second connectors 120a-120f through respective power lines 142. Thus, for instance, power may be supplied from the first connector 110, through the power converters 140a, and onto the second connectors 120a-120f.

The power converters 140a-140f may be any suitable converters, i.e., circuits and other hardware, that are to convert voltage supplied through the power line 112 from a first voltage to a second voltage. For instance, the power converters 140a-140f are direct-current (DC) to DC converters and are to down-convert a voltage. Various manners in which the power converters 140a-140f may function are described in greater detail herein below.

The power lines 112 and 142 may be any suitable types of wires or conductors over which power may be supplied. Moreover, the first connector 110 and the second connectors 120a-120f may be any suitable type of male or female connector through which power and communication signals may be conveyed. In addition, the first connector 110 may or may not have the same configuration and/or size as the second connectors 120a-120f. Thus, the adapter 100 may enable interconnection of differently configured connectors on a power supply and an electronic component.

The controller 130 may be connected to the first connector 110 and to each of the second connectors 120a-120f through a plurality of communication signal lines 132. The communication signal lines 132 are shown in dashed lines to more readily distinguish them from the power lines 112, 142. Generally speaking, the controller 130 may operate as a logic device in the adapter 100 and may be a field programmable gate array (FPGA), an application specific integrated circuit (ASIC), a central processing unit (CPU), a microprocessor, a general purpose processor, etc. The controller 130 may include firmware and/or may access machine readable instructions stored, for instance, in a machine readable medium, that when executed by the controller 130 cause the controller 130 to perform various functions in the adapter.

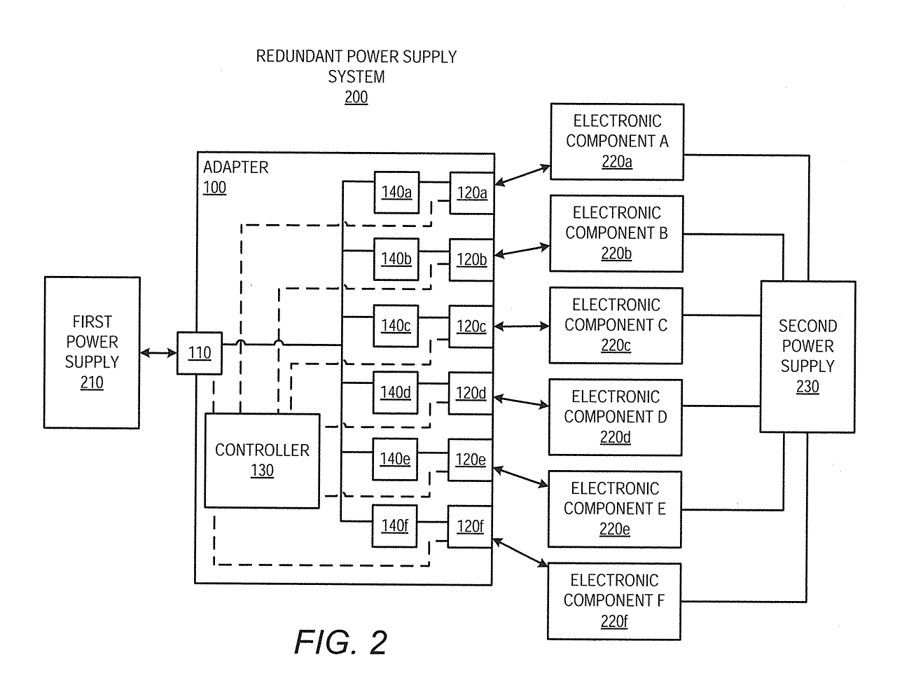

For instance, the controller 130 may receive signals from the second connectors 120a-120f when electronic components (shown in FIG. 2) are connected to the second connectors 120a-120f to detect when the electronic components are connected to the second connectors 120a-120f. By way of example, when an electronic component is connected to a second connector 120a, a signal indicative of the connection may be communicated to the controller 130. The signal may originate in the electronic component and/or the second connector 120a and may be communicated to the controller 130 through a communication signal line 132. The controller 130 may use the signal to identify that an electronic component is connected to the second connector 120a.

The controller 130 may also detect when a fault has occurred on an electronic component, such as when the power supplied by a primary power source to the electronic component has decreased or stopped. The controller 130 may make this determination based upon signals received from the second connector 120a via the communication signal line 132. That is, for instance, the electronic component may output a signal to the controller 130 through the second connector 120a that additional power is required. In addition, or alternatively, the controller 130 may monitor the power consumed by the electronic component from the primary power source (or supply), and may determine when the fault occurs.

The controller 130 may further request allocation of power from a redundant power supply (shown in FIG. 2) connected to the first connector 110 in response to detection of the fault. That is, the controller 130 may negotiate with the redundant power supply (or source) for the allocation of power to be delivered through the adapter 100 and to the electronic component that suffered the fault. In response, the redundant power supply may supply the requested power through the first connector 110, which may be delivered through the second connector 120a to which the electronic component is connected. As discussed in greater detail herein below, the power supplied by the redundant power supply may be at a different voltage than the voltage at which the electronic component is to operate. In this regard, the power converter 140a may convert the voltage of the power outputted from the redundant power supply to the voltage at which the electronic component is to operate.

Although the adapter 100 has been depicted as being contained in a single housing, it should be understood that the adapter 100 may have different physical configurations without departing from a scope of the adapter 100. That is, for instance, each of the second connectors 120a-120f may be housed in individual sections of a housing such that the individual sections are flexibly movable with respect to each other. As such, for instance, the adapter 100 may provide redundant power to electronic components that may be physically separate from each other.

Turning now to FIG. 2, there is shown a simplified block diagram of a redundant power supply system 200 containing the adapter depicted in FIG. 1, according to an example. It should be understood that the redundant power supply system 200 may include additional elements and that some of the elements depicted therein may be removed and/or modified without departing from a scope of the redundant power supply system 200. For instance, although the adapter 100 has been depicted as being connected to six electronic components 220a-220f, it should be clearly understood that the adapter 100 may be connected to any reasonable number of electronic components 220a-220f without departing from a scope of the adapter 100.

As shown in FIG. 2, redundant power supply system 200 includes the adapter 100 discussed above with respect to FIG. 1, a first power supply 210, a plurality of electronic components 220a-220f, and a second power supply 230. Particularly, the first power supply 210 may be connected to the first connector 110 and the electronic components 220a-220f may be connected to respective ones of the second connectors 120a-120f. According to an example, the second power supply 230 is a primary power source for the electronic components 220a-220f and the first power supply 210 is a redundant power source for the electronic components 220a-220f. That is, the second power supply 230 is to primarily supply power to the electronic components 220a-220f and the first power supply 210 is to supply power to the electronic components 220a-220f through the adapter 100 in the event that power from the second power supply 230 is interrupted or stopped.

The electronic components 220a-220f may be any type of electronic component that may receive power primarily from a primary power supply and may receive power redundantly from a redundant power supply. Examples of suitable electronic components 220a-220f may include, for instance, network switches, servers, computers, etc. In addition, the first power supply 210 may be a power supply available from the Hewlett Packard Company™ of Palo Alto, Calif.

As discussed above, the adapter 100 may include a controller 130 that may detect when the electronic components 220a-220f are connected to the second connectors 120a-120f. The controller 130 may also detect when a fault in the supply of power from the second power supply 230 to any of the electronic components 220a-220f occurs and may request allocation of power from the first power supply 210 to supply the electronic components 220a-220f with redundant power.

According to an example, the first power supply 210 includes an interface through which the first power supply 210 is to supply power at a first voltage, which may differ from a second voltage at which the electronic components 220a-220f are to operate. By way of particular example, the first power supply 210 is to supply power over Ethernet (PoE) such that the voltage of the power supplied is at the first voltage. In addition, the electronic components 220a-220f are non-PoE components and thus operate a second voltage that is lower than the first voltage. That is, for instance, the first power supply 210 may include a plurality of channels, in which the first power supply 210 may output power at 54V through each of the channels. In this example, the electronic components 220a-220f may operate at 12V.

As discussed herein above, the adapter 100 may include power converters 140a-140f that are to convert the power from 54V to 12V, such that the power is suitable for use by the electronic components 220a-220f. The adapter 100 may therefore allow for a relatively larger number of electronic components 220a-220f to be redundantly powered by the first power supply 210 than the number of channels contained in the first power supply 210. In one regard, therefore, the adapter 100 may split the power outputted by the first power supply 210 to multiple destinations. In addition, the adapter 100 generally enables the use of fewer redundant power supplies to power a number of electronic components 220a-220f.

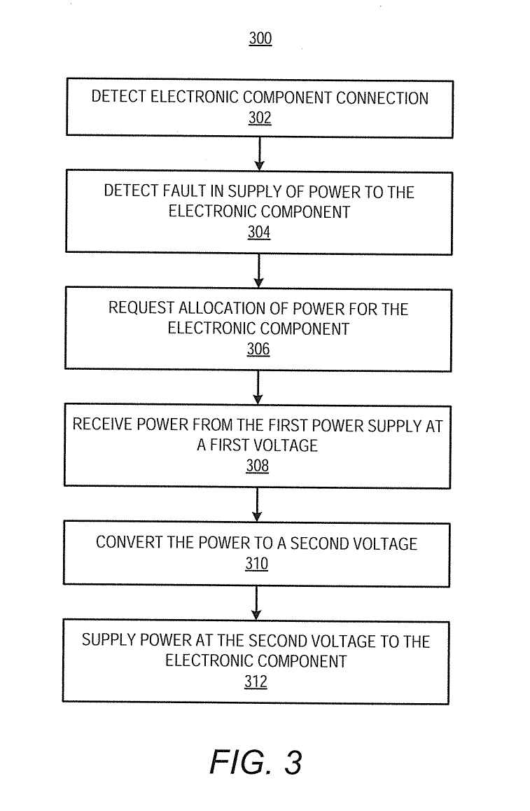

Turning now to FIG. 3, there is shown a flow diagram of a method 300 of implementing an adapter 100 to supply redundant power to a plurality of electronic components 220a-220f, according to an example. It should be apparent to those of ordinary skill in the art that the method 300 represents a generalized illustration and that other operations may be added or existing operations may be removed, modified or rearranged without departing from a scope of the method 300.

At block 302, a connection between an electronic component 220a and a second connector 120a of the adapter 100 may be detected, for instance, by the controller 130. The controller 130 may detect the connection in any of the manners discussed above.

At block 304, a fault in the supply of power to the electronic component 220a from the second power supply 230 may be detected, for instance, by the controller 130. As discussed above, the controller 130 may detect the fault based upon, for instance, the electronic component 220a requiring additional power from the first power supply 210. That is, under normal operating conditions, the electronic component 220 may receive power from both the second power supply 230 and the first power supply 210. In the event that the second power supply 230 ceases supplying power or the amount of power being supplied by the second power supply 230 decreases, the electronic component 220a may require additional power from the first power supply 210 to compensate for the reduction or loss in power from the second power supply 230.

At block 306, in response to detection of the fault, allocation of power for the electronic component 220a may be requested from the first power supply, for instance, by the controller 130. That is, the controller 130 may communicate a request to the first power supply 210 for the power allocation through the connection with the first power supply 210 at the first connector 110. In response, the first power supply 210 may supply power through the channel that is connected to the first connector 110.

At block 308, power may be received into the first connector 110 from the first power supply 210 at a first voltage. In addition, at block 310, the received power may be converted to a second voltage, for instance, by a power converter 140a inside the adapter 100. As discussed above, the first power supply 210 may supply power at a first voltage that is intended for a PoE device, whereas the electronic component 220a may be a non-PoE device. In this regard, the power converter 140a may convert the power from the first voltage to a second voltage at which electronic component 220a is to operate. The power converter 140a may include any suitable circuitry or other components to perform the conversion.

At block 312, power at the second voltage may be supplied to the electronic component 220a through the second connector 120a. The electronic component 220a may therefore receive back-up or redundant power from the first power supply 210 in the event that the second power supply 230 fails.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An adapter to provide power to a plurality of electronic components from a first power supply, said adapter comprising:
a first connector to connect to the first power supply;
a plurality of second connectors to connect to the plurality of electronic components;
a plurality of lines connecting the first connector to each of the second connectors, wherein each of the plurality of electronic components is to receive power from the first power supply through the plurality of lines; and
a controller to detect a fault in the receipt of power from a second power supply in an electronic component of the plurality of electronic components and wherein the controller is to request allocation of power from the first power supply to supply power to the electronic component.

2. The adapter according to claim 1, further comprising:
a plurality of power converters positioned along the plurality of lines connecting the first connector to each of the plurality of second connectors.

3. The adapter according to claim 2, wherein the first power supply is to provide power over Ethernet (POE) at a first voltage, wherein the plurality of electronic components comprise non-POE components that are to use a second voltage that is lower than the first voltage, and wherein the plurality of power converters are to convert the power outputted from the first power supply to the second voltage.

4. The adapter according to claim 2, wherein the plurality of power converters comprise first voltage direct-current (DC) to second voltage DC converters.

5. The adapter according to claim 2, wherein the plurality of power converters are to convert power from 54V to 12V.

6. The adapter according to claim 1, wherein the plurality of electronic components comprise network switches that are not to receive redundant power over a power over Ethernet connection.

7. The adapter according to claim 1, wherein the controller comprises a control device selected from the group consisting of a field programmable gate array, an application specific integrated circuit, and a processor.

8. The adapter according to claim 1, wherein the controller is to further detect when the plurality of electrical components are connected to the second connectors.

9. A method of implementing an adapter to supply redundant power to a plurality of electronic components from a first power supply, said adapter having a controller and a plurality of power converters, said method comprising:
detecting, in the controller, a fault in the receipt of power from a second power supply in an electronic component of the plurality of electronic components;
requesting, by the controller, allocation of power to be supplied to the electronic component from the first power supply;
receiving power from the first power supply at a first voltage;
converting, in a power converter of the plurality of power converters, the power to a second voltage; and
supplying the power at the second voltage to the electronic component.

10. The method according to claim 9, wherein the adapter comprises a first connector connected to the first power supply and a plurality of second connectors respectively connected to the plurality of electronic components, said method further comprising:
detecting, in the controller, connections between the plurality of electronic components and the plurality of second connectors.

11. The method according to claim 9, wherein the plurality of electronic components are to receive power from a second power supply, wherein detecting a fault in an electronic components further comprises detecting a fault in the receipt of power from the second power supply.

12. The method according to claim 9, wherein the first power supply provides power over Ethernet (POE) at the first voltage, wherein the plurality of electronic components comprise non-POE components that are to operate under the second voltage.

13. An adapter to provide power from a first power supply to a plurality of electronic components, said adapter comprising:
a first connector to connect to the first power supply;
a plurality of second connectors to connect to the plurality of electronic components;
a plurality of lines connecting the first connector to each of the second connectors;
a controller to detect a fault in a receipt of power from a second power supply in an electronic component of the plurality of electronic components, wherein the controller is to request allocation of power from the first power supply to supply power to the electronic component, and wherein the electronic component is a non-power over Ethernet device; and
a plurality of power converters positioned along the plurality of lines to convert voltage of power received from the first power supply from a first voltage to a second voltage, wherein the first voltage is to be used by a power over Ethernet device and the second voltage is to be used by a non-power over Ethernet device.

14. The adapter according to claim 13, wherein the plurality of electronic components comprise network switches that are non-power over Ethernet devices.

15. The adapter according to claim 13, wherein the controller is to further detect when the plurality of electrical components are connected to the second connectors.
